(19) United States
(12) Patent Application Publication
(10) Pub. No.: US 2013/0219046 A1
(43) Pub. Date: Aug. 22, 2013

(54) DYNAMIC APPLICATION-AWARE ROUTING TOPOLOGIES

(71) Applicants: Patrick Wetterwald, Mouans Sartoux (FR); Jean-Philippe Vasseur, Saint Martin d'Uriage (FR)

(72) Inventors: Patrick Wetterwald, Mouans Sartoux (FR); Jean-Philippe Vasseur, Saint Martin d'Uriage (FR)

(73) Assignee: Cisco Technology, Inc., San Jose, CA (US)

(21) Appl. No.: 13/400,884

(22) Filed: Feb. 21, 2012

(51) Int. Cl. G06F 15/173

(52) U.S. Cl. 709/224; 709/238

(57) ABSTRACT

In one embodiment, an application flow of traffic may be detected within a computer network, e.g., by a root node, border router, network management server, etc. Thereafter, one or more traffic requirements of the application flow may be determined, and a corresponding routing topology objective function may be established based on the traffic requirements. Accordingly, creation of a specific routing topology based on the objective function may then be initiated for use with the application flow.

### TECHNICAL FIELD

The present disclosure relates generally to computer networks, and, more particularly, to routing topologies within computer networks.

### BACKGROUND

Many computer networks, such as sensor networks (e.g., smart grids or smart cities) support different types of traffic flows or applications. For instance, in the case of smart metering, a typical non-critical flow consists of reading the meter information on a regular basis (e.g., from every 15 minutes to once a day), but it is also required to download new firmware updates to the meter, send time critical flows related to alarms, send control commands for distributed automation, etc. With the current solutions, a single routing topology is generally deployed (e.g., called a directed acyclic graph or “DAG” when using a pro-active routing protocol such as the Routing Protocol for Low Power and Lossy Networks (LLNs), or simply “RPL”), where concurrent flows are carried out and compete for resources while using differentiated services thanks to various known quality of service (QoS) techniques.

That being said, it may be desired to build multiple topologies based on the traffic flow requirements (e.g., latency, bandwidth, jitter, etc.). For instance, one particular example where this is currently done is in home networks where there is a need to support different flows such as video and audio streaming, as well as home automation, alarm systems, or energy monitoring application flows. It is well-known that the routing topology for video streaming has very different networking requirements than the one used for, e.g., the remote control and alarm systems.

The current approach, such as Multi-Topology Routing (MTR), consists of manually building different routing topologies based on pre-defined configuration and rules. The major challenge with such as a static approach lies in that it requires a fine grained a priori knowledge of traffic flows, which may not always be known. Furthermore, this approach requires multiple topologies to co-exist even if there is no associated traffic flowing, thus involving costly state maintenance in the nodes of the network, a very problematic issue in constrained environments.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example communication network;

FIG. 2 illustrates an example network device/node;

FIG. 3 illustrates an example message format;

FIG. 4 illustrates an example directed acyclic graph (DAG) in the communication network as in FIG. 1;

FIG. 5 illustrates an example of application flows in the DAG of FIG. 4;

FIG. 6 illustrates an example packet;

FIG. 7 illustrates an example message exchange;

FIG. 8 illustrates an example of a dynamically created application-aware routing topology (e.g., DAG);

FIG. 9 illustrates another example message exchange; and

FIGS. 10A-10B illustrate an example simplified procedure for dynamic application-aware routing topologies in a computer network.

### DESCRIPTION OF EXAMPLE EMBODIMENTS

### Overview

According to one or more embodiments of the disclosure, an application flow of traffic may be detected within a computer network, e.g., by a root node, border router, network management server, etc. Thereafter, one or more traffic requirements of the application flow may be determined, and a corresponding routing topology objective function may be established based on the traffic requirements. Accordingly, creation of a specific routing topology based on the objective function may then be initiated for use with the application flow.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC) such as IEEE 61334, IEEE P1901.2, and others. In addition, a Mobile Ad-Hoc Network (MANET) is a kind of wireless ad-hoc network, which is generally considered a self-configuring network of mobile routes (and associated hosts) connected by wireless links, the union of which forms an arbitrary topology.

Smart object networks, such as sensor networks, in particular, are a specific type of network having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Often, smart object networks are considered field area networks (FANs), neighborhood area networks (NANs), etc. Generally, size and cost constraints on smart object nodes (e.g., sensors) result in corresponding constraints on resources such as energy, memory, computational speed and bandwidth. Correspondingly, a reactive routing protocol may, though need not, be used in place of a proactive routing protocol for smart object networks.

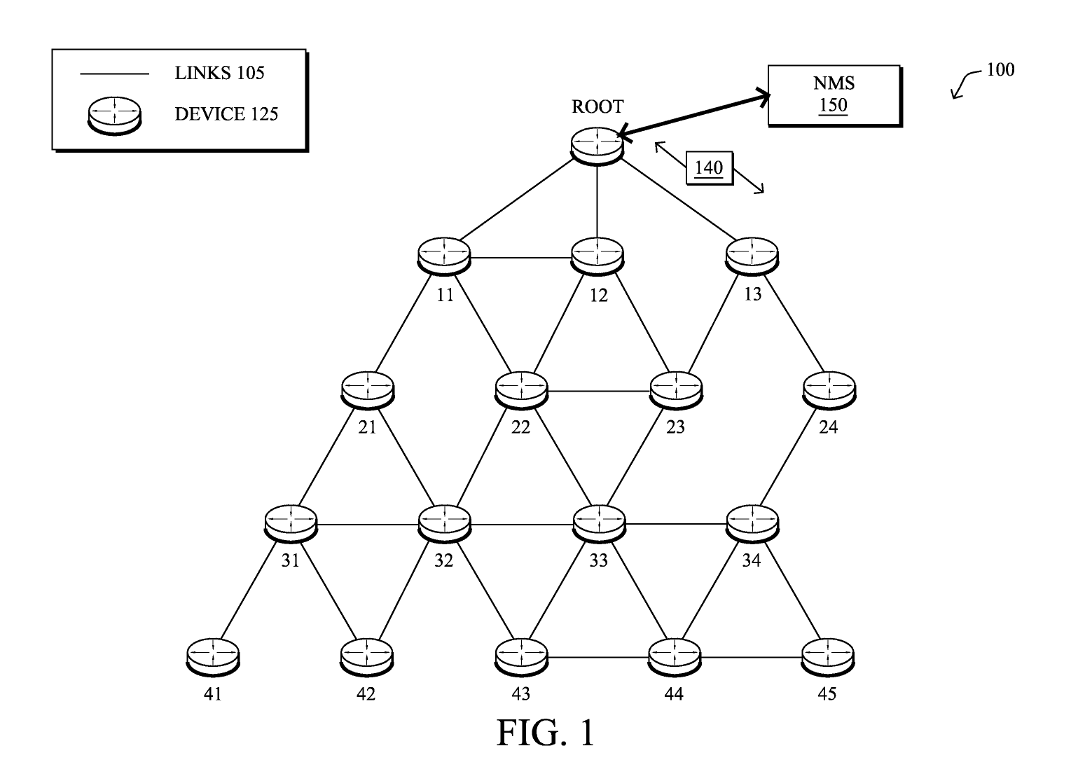

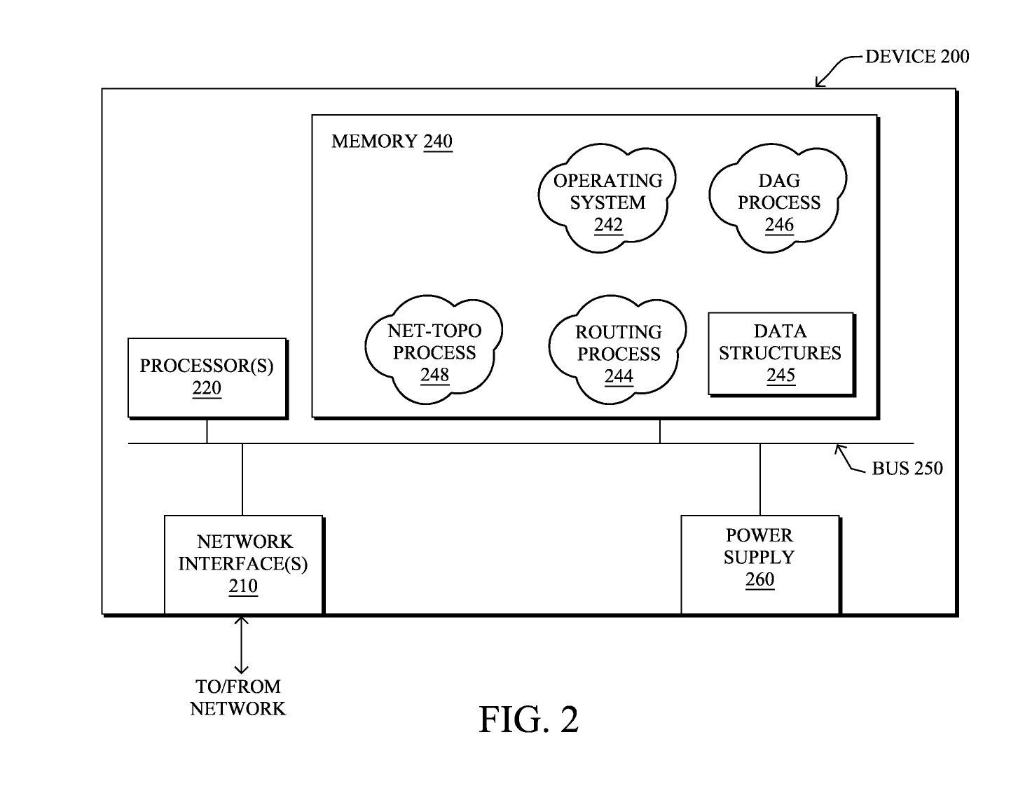

FIG. 1 is a schematic block diagram of an example computer network 100 illustratively comprising nodes/devices 125 (e.g., labeled as shown, “root,” “11,” “12,” . . . “45,” and described in FIG. 2 below) interconnected by various methods of communication. For instance, the links 105 may be wired links or shared media (e.g., wireless links, PLC links, etc.) where certain nodes 125, such as, e.g., routers, sensors, computers, etc., may be in communication with other nodes 125, e.g., based on distance, signal strength, current operational status, location, etc. In addition, various other devices, such as a head-end application device or a network management server (NMS) 150 may be present in the network 100, such as via a WAN reachable by node 11-45 through the root node. Those skilled in the art will understand that any number of nodes, devices, links, etc. may be used in the computer network, and that the view shown herein is for simplicity. Also, those skilled in the art will further understand that while the network is shown in a certain orientation, particularly with a “root” node, the network 100 is merely an example illustration that is not meant to limit the disclosure.

Data packets 140 (e.g., traffic and/or messages sent between the devices/nodes) may be exchanged among the nodes/devices of the computer network 100 using predefined network communication protocols such as certain known wired protocols, wireless protocols (e.g., IEEE Std. 802.15.4, WiFi, Bluetooth®, etc.), PLC protocols, or other shared-media protocols where appropriate. In this context, a protocol consists of a set of rules defining how the nodes interact with each other.

FIG. 2 is a schematic block diagram of an example node/device 200 that may be used with one or more embodiments described herein, e.g., particularly as the root node or NMS 150. The device may comprise one or more network interfaces 210 (e.g., wired, wireless, PLC, etc.), at least one processor 220, and a memory 240 interconnected by a system bus 250, as well as a power supply 260 (e.g., battery, plug-in, etc.).

The network interface(s) 210 contain the mechanical, electrical, and signaling circuitry for communicating data over links 105 coupled to the network 100. The network interfaces may be configured to transmit and/or receive data using a variety of different communication protocols. Note, further, that the nodes may have two different types of network connections 210, e.g., wireless and wired/physical connections, and that the view herein is merely for illustration. Also, while the network interface 210 is shown separately from power supply 260, for PLC the network interface 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interfaces 210 for storing software programs and data structures associated with the embodiments described herein. Note that certain devices may have limited memory or no memory. The processor 220 may comprise necessary elements or logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise routing process/services 244, a directed acyclic graph (DAG) process 246, and an illustrative network topology (“net-topo”) process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

Routing process (services) 244 contains computer executable instructions executed by the processor 220 to perform functions provided by one or more routing protocols, such as proactive or reactive routing protocols as will be understood by those skilled in the art. These functions may, on capable devices, be configured to manage a routing/forwarding table (a data structure 245) containing, e.g., data used to make routing/forwarding decisions. In particular, in proactive routing, connectivity is discovered and known prior to computing routes to any destination in the network, e.g., link state routing such as Open Shortest Path First (OSPF), or Intermediate-System-to-Intermediate-System (ISIS), or Optimized Link State Routing (OLSR). Reactive routing, on the other hand, discovers neighbors (i.e., does not have an a priori knowledge of network topology), and in response to a needed route to a destination, sends a route request into the network to determine which neighboring node may be used to reach the desired destination. Example reactive routing protocols may comprise Ad-hoc On-demand Distance Vector (AODV), Dynamic Source Routing (DSR), DYnamic MANET On-demand Routing (DYMO), etc. Notably, on devices not capable or configured to store routing entries, routing process 244 may consist solely of providing mechanisms necessary for source routing techniques. That is, for source routing, other devices in the network can tell the less capable devices exactly where to send the packets, and the less capable devices simply forward the packets as directed.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and

6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid, smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

An example protocol specified in an Internet Engineering Task Force (IETF) Internet Draft, entitled “RPL: IPv6 Routing Protocol for Low Power and Lossy Networks” <draft-ietf-roll-rpl-19> by Winter, et al. (Mar. 13, 2011 version), provides a mechanism that supports multipoint-to-point (MP2P) traffic from devices inside the LLN towards a central control point (e.g., LLN Border Routers (LBRs) or “root nodes/devices” generally), as well as point-to-multipoint (P2MP) traffic from the central control point to the devices inside the LLN (and also point-to-point, or “P2P” traffic). RPL (pronounced “ripple”) may generally be described as a distance vector routing protocol that builds a Directed Acyclic Graph (DAG) for use in routing traffic/packets 140, in addition to defining a set of features to bound the control traffic, support repair, etc. Notably, as may be appreciated by those skilled in the art, RPL also supports the concept of Multi-Topology-Routing (MTR), whereby multiple DAGs can be built to carry traffic according to individual requirements.

A DAG is a directed graph having the property that all edges (and/or vertices) are oriented in such a way that no cycles (loops) are supposed to exist. All edges are contained in paths oriented toward and terminating at one or more root nodes (e.g., “clusterheads or “sinks”), often to interconnect the devices of the DAG with a larger infrastructure, such as the Internet, a wide area network, or other domain. In addition, a Destination Oriented DAG (DODAG) is a DAG rooted at a single destination, i.e., at a single DAG root with no outgoing edges. A “parent” of a particular node within a DAG is an immediate successor of the particular node on a path towards the DAG root, such that the parent has a lower “rank” than the particular node itself, where the rank of a node identifies the node's position with respect to a DAG root (e.g., the farther away a node is from a root, the higher is the rank of that node). Further, in certain embodiments, a sibling of a node within a DAG may be defined as any neighboring node which is located at the same rank within a DAG. Note that siblings do not necessarily share a common parent, and routes between siblings are generally not part of a DAG since there is no forward progress (their rank is the same). Note also that a tree is a kind of DAG, where each device/node in the DAG generally has one parent or one preferred parent.

DAGs may generally be built (e.g., by DAG process 246) based on an Objective Function (OF). The role of the Objective Function is generally to specify rules on how to build the DAG (e.g. number of parents, backup parents, etc.).

In addition, one or more metrics/constraints may be advertised by the routing protocol to optimize the DAG against. Also, the routing protocol allows for including an optional set of constraints to compute a constrained path, such as if a link or a node does not satisfy a required constraint, it is “pruned” from the candidate list when computing the best path. (Alternatively, the constraints and metrics may be separated from the OF.) Additionally, the routing protocol may include a “goal” that defines a host or set of hosts, such as a host serving as a data collection point, or a gateway providing connectivity to an external infrastructure, where a DAG's primary objective is to have the devices within the DAG be able to reach the goal. In the case where a node is unable to comply with an objective function or does not understand or support the advertised metric, it may be configured to join a DAG as a leaf node. As used herein, the various metrics, constraints, policies, etc., are considered “DAG parameters.”

Illustratively, example metrics used to select paths (e.g., preferred parents) may comprise cost, delay, latency, bandwidth, expected transmission count (ETX), etc., while example constraints that may be placed on the route selection may comprise various reliability thresholds, restrictions on battery operation, multipath diversity, bandwidth requirements, transmission types (e.g., wired, wireless, etc.). The OF may provide rules defining the load balancing requirements, such as a number of selected parents (e.g., single parent trees or multi-parent DAGs). Notably, an example for how routing metrics and constraints may be obtained may be found in an IETF Internet Draft, entitled “Routing Metrics used for Path Calculation in Low Power and Lossy Networks” <draft-ietf-roll-routing-metrics-19> by Vasseur, et al. (Mar. 1, 2011 version). Further, an example OF (e.g., a default OF) may be found in an IETF Internet Draft, entitled “RPL Objective Function 0” <draft-ietf-roll-of0-15> by Thubert (Jul. 8, 2011 version) and “The Minimum Rank Objective Function with Hysteresis” <draft-ietf-roll-minrank-hysteresis-of-04> by O. Gnawali et al. (May 17, 2011 version).

Building a DAG may utilize a discovery mechanism to build a logical representation of the network, and route dissemination to establish state within the network so that routers know how to forward packets toward their ultimate destination. Note that a “router” refers to a device that can forward as well as generate traffic, while a “host” refers to a device that can generate but does not forward traffic. Also, a “leaf” may be used to generally describe a non-router that is connected to a DAG by one or more routers, but cannot itself forward traffic received on the DAG to another router on the DAG. Control messages may be transmitted among the devices within the network for discovery and route dissemination when building a DAG.

According to the illustrative RPL protocol, a DODAG Information Object (DIO) is a type of DAG discovery message that carries information that allows a node to discover a RPL Instance, learn its configuration parameters, select a DODAG parent set, and maintain the upward routing topology. In addition, a Destination Advertisement Object (DAO) is a type of DAG discovery reply message that conveys destination information upwards along the DODAG so that a DODAG root (and other intermediate nodes) can provision downward routes. A DAO message includes prefix information to identify destinations, a capability to record routes in support of source routing, and information to determine the freshness of a particular advertisement. Notably, “upward” or “up” paths are routes that lead in the direction from leaf nodes towards DAG roots, e.g., following the orientation of the edges within the DAG. Conversely, “downward” or “down” paths are routes that lead in the direction from DAG roots towards leaf nodes, e.g., generally going in the opposite direction to the upward messages within the DAG.

Generally, a DAG discovery request (e.g., DIO) message is transmitted from the root device(s) of the DAG downward toward the leaves, informing each successive receiving device how to reach the root device (that is, from where the request is received is generally the direction of the root). Accordingly, a DAG is created in the upward direction toward the root device. The DAG discovery reply (e.g., DAO) may then be returned from the leaves to the root device(s) (unless unnecessary, such as for UP flows only), informing each successive receiving device in the other direction how to reach the leaves for downward routes. Nodes that are capable of maintaining routing state may aggregate routes from DAO messages that they receive before transmitting a DAO message. Nodes that are not capable of maintaining routing state, however, may attach a next-hop parent address. The DAO message is then sent directly to the DODAG root that can in turn build the topology and locally compute downward routes to all nodes in the DODAG. Such nodes are then reachable using source routing techniques over regions of the DAG that are incapable of storing downward routing state. In addition, RPL also specifies a message called the DIS (DODAG Information Solicitation) message that is sent under specific circumstances so as to discover DAG neighbors and join a DAG or restore connectivity.

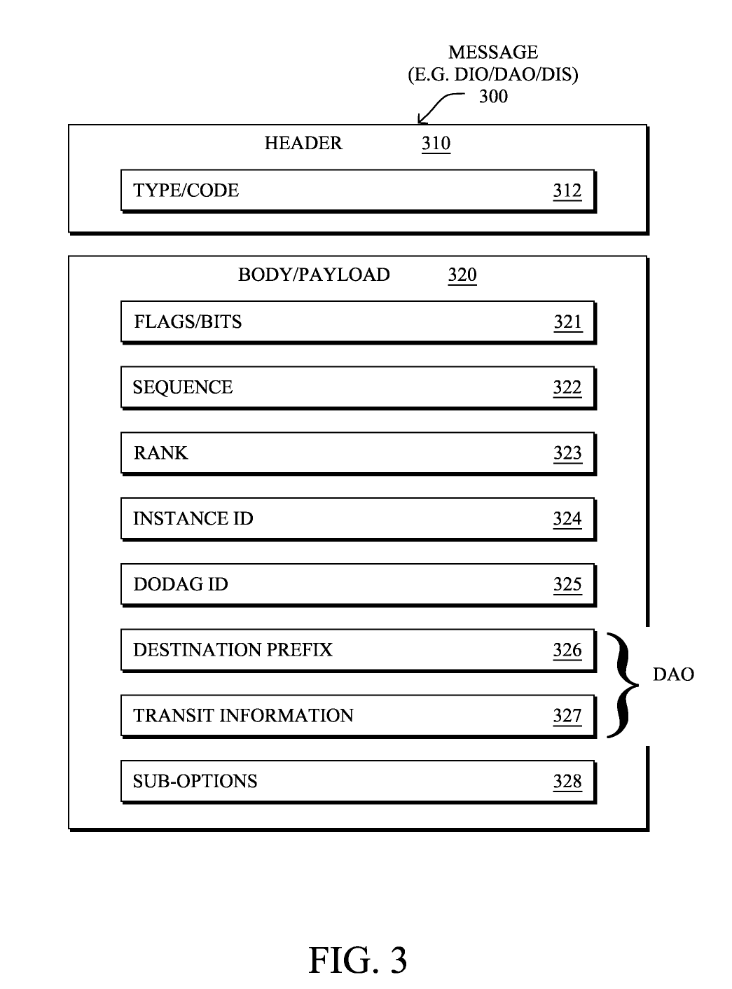

FIG. 3 illustrates an example simplified control message format 300 that may be used for discovery and route dissemination when building a DAG, e.g., as a DIO, DAO, or DIS message. Message 300 illustratively comprises a header 310 with one or more fields 312 that identify the type of message (e.g., a RPL control message), and a specific code indicating the specific type of message, e.g., a DIO, DAO, or DIS. Within the body/payload 320 of the message may be a plurality of fields used to relay the pertinent information. In particular, the fields may comprise various flags/bits 321, a sequence number 322, a rank value 323, an instance ID 324, a DODAG ID 325, and other fields, each as may be appreciated in more detail by those skilled in the art. Further, for DAO messages, additional fields for destination prefixes 326 and a transit information field 327 /may also be included, among others (e.g., DAO_Sequence used for ACKs, etc.). For any type of message 300, one or more additional sub-option fields 328 may be used to supply additional or custom information within the message 300. For instance, an objective code point (OCP) sub-option field may be used within a DIO to carry codes specifying a particular objective function (OF) to be used for building the associated DAG. Alternatively, sub-option fields 328 may be used to carry other certain information within a message 300, such as indications, requests, capabilities, lists, notifications, etc., as may be described herein, e.g., in one or more type-length-value (TLV) fields.

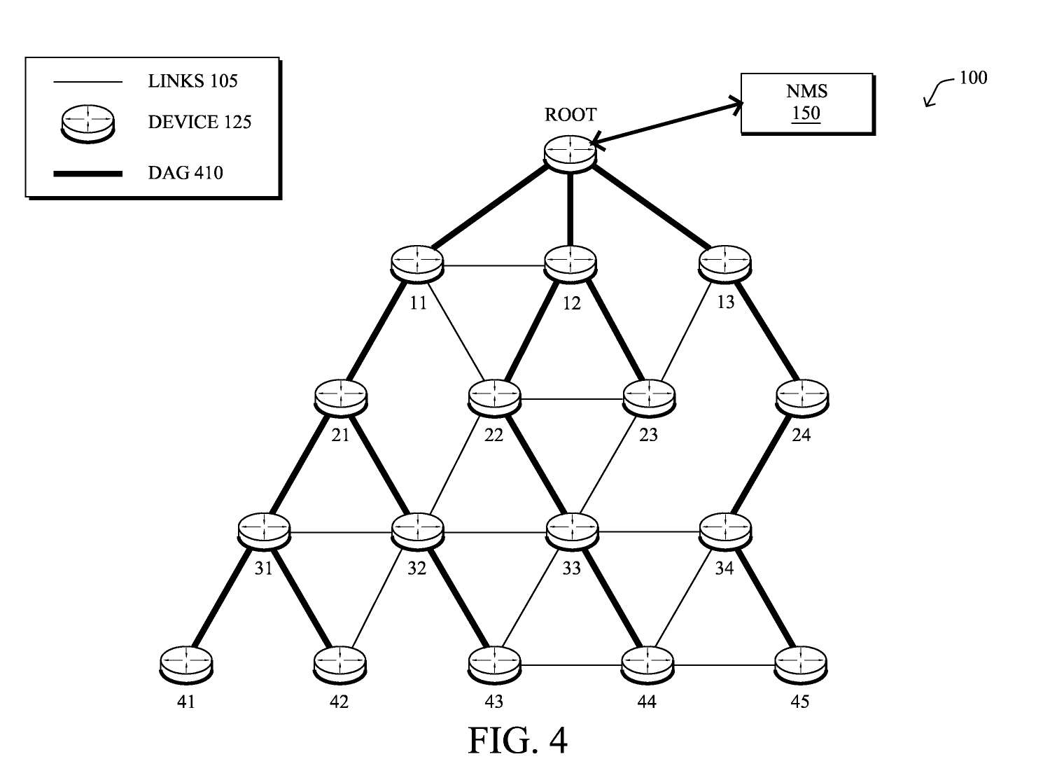

FIG. 4 illustrates an example simplified DAG that may be created, e.g., through the techniques described above, within network 100 of FIG. 1. For instance, certain links 105 may be selected for each node to communicate with a particular parent (and thus, in the reverse, to communicate with a child, if one exists). These selected links form the DAG 410 (shown as bolded lines), which extends from the root node toward one or more leaf nodes (nodes without children). Traffic/packets 140 (shown in FIG. 1) may then traverse the DAG 410 in either the upward direction toward the root or downward toward the leaf nodes, particularly as described herein.

As noted above, many computer networks, such as sensor networks (e.g., smart grids or smart cities) support different types of traffic flows or applications. For instance, in the case of smart metering, a typical non-critical flow consists of reading the meter information on a regular basis, but it is also required to download new firmware updates to the meter, send time critical flows related to alarms, send control commands for distributed automation, etc. With the current solutions, a single routing topology is generally deployed (e.g., DAG 410), where concurrent flows are carried out and compete for resources while using differentiated services thanks to various known quality of service (QoS) techniques.

In the case of LLNs designed for multi-service, for example, the objective is to host a number of applications with different requirements. For example, it is common to have many different links with different characteristics in terms of delays, bandwidth, etc. Similarly, LLNs are made of nodes with mixed capabilities in terms of processing, bandwidth, and energy. Consider the case of two flows, one requiring very low delays and high reliability and the other one being less time critical but larger flows. Using one routing topology in this instance would mean that delay sensitive traffic would indeed get higher priority, but non-real-time traffic would also transit through battery operated devices.

Accordingly, it may be desired to build multiple topologies based on the traffic flow requirements (e.g., latency, bandwidth, jitter, etc.). For instance, in the example above, it is desirable to have two routing topologies: one optimized for delays (critical traffic) that will traverse nodes that may be battery operated, the other one that will provide less optimum paths but would not use any battery operated devices (to save energy on battery operated devices). One particular example where multiple topologies are currently implemented is in home networks where there is a need to support different flows such as video and audio streaming, as well as home automation, alarm systems, or energy monitoring application flows. It is well-known that the routing topology for video streaming has very different networking requirements than the one used for, e.g., the remote control and alarm systems.

However, the current approach, such as Multi-Topology Routing (MTR), consists of manually building different routing topologies based on pre-defined configuration and rules. The major challenge with such as a static approach lies in that it requires a fine grained a priori knowledge of traffic flows, which may not always be known. Furthermore, this approach requires multiple topologies to co-exist even if there is no associated traffic flowing, thus involving costly state maintenance in the nodes of the network, a very problematic issue in constrained environments.

Dynamic Application-Aware Routing Topology

The techniques herein specify a mechanism hosted on a root node, border router, or NMS 150 that dynamically detects traffic flows and may locally decide whether a new routing topology should be built along with associated traffic requirements, and if such a routing topology is required, then associated routing objective functions may be determined to form such new routing topologies. Said differently, according to one or more embodiments of the disclosure as described in detail below, an application flow of traffic may be detected within a computer network, e.g., by a root node, border router, network management server, etc. Thereafter, one or more traffic requirements of the application flow may be determined, and a corresponding routing topology objective function may be established based on the traffic requirements. Accordingly, creation of a specific routing topology based on the objective function may then be initiated for use with the application flow. Other mechanisms are also specified to avoid transient formation/tear-down of routing topologies, and to dynamically adapt the routing topology according to observed traffic flows and required service level agreements (SLAs).

Illustratively, the techniques described herein may be performed by hardware, software, and/or firmware, such as in accordance with the “net-topo” process 248, which may contain computer executable instructions executed by the processor 220 to perform functions relating to the techniques described herein, e.g., in conjunction with routing process 244 (and/or DAG process 246). For example, the techniques herein may be treated as extensions to conventional protocols, such as the illustrative RPL protocol, and as such, may be processed by similar components understood in the art that execute those protocols, accordingly. Note that RPL is good example of a routing protocol capable of building different topologies based on traffic requirements according to different objective functions and routing metrics, but the embodiments herein are not specific to RPL, and can be used with other routing protocols.

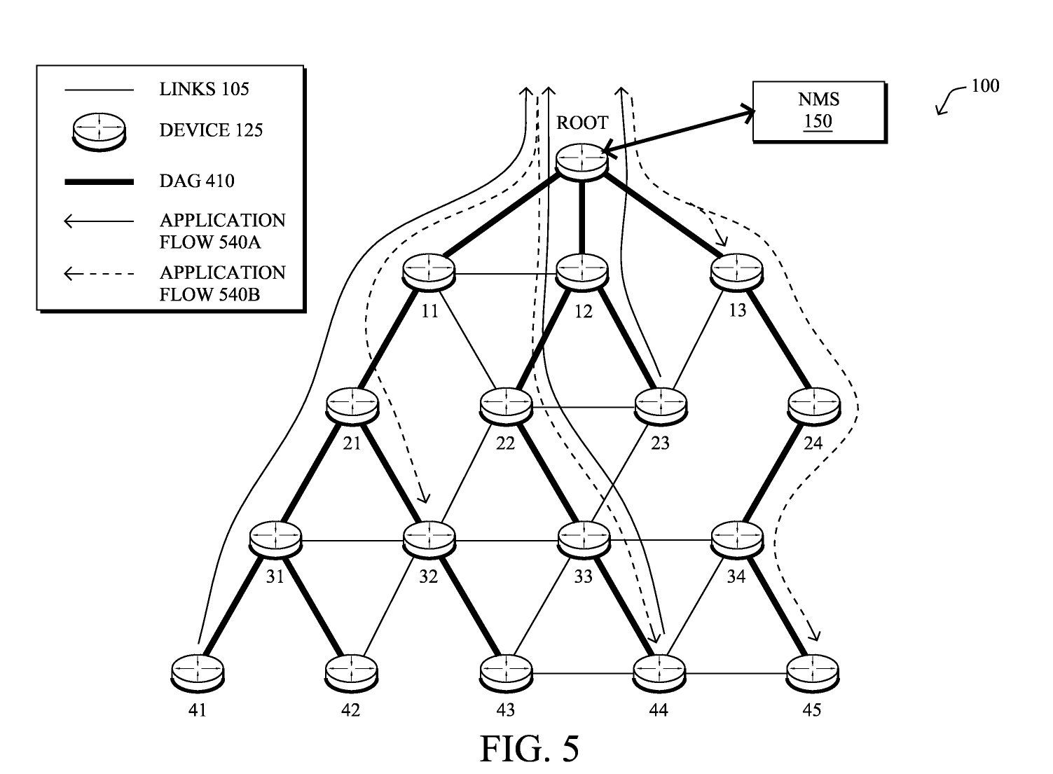

Operationally, the techniques herein first detect application flows of traffic within the computer network. For instance, with reference to FIG. 5, the root node may monitor the traffic (e.g., packets 140) through the network to detect one or more applications flows 540, such as illustrative flows 540A and 540B. Generally, flows may be unidirectional (in either direction across the root node), or bidirectional. Known detection mechanisms such as network based application recognition (NBAR) and deep packet inspection (DPI) may be used to detect the traffic flows.

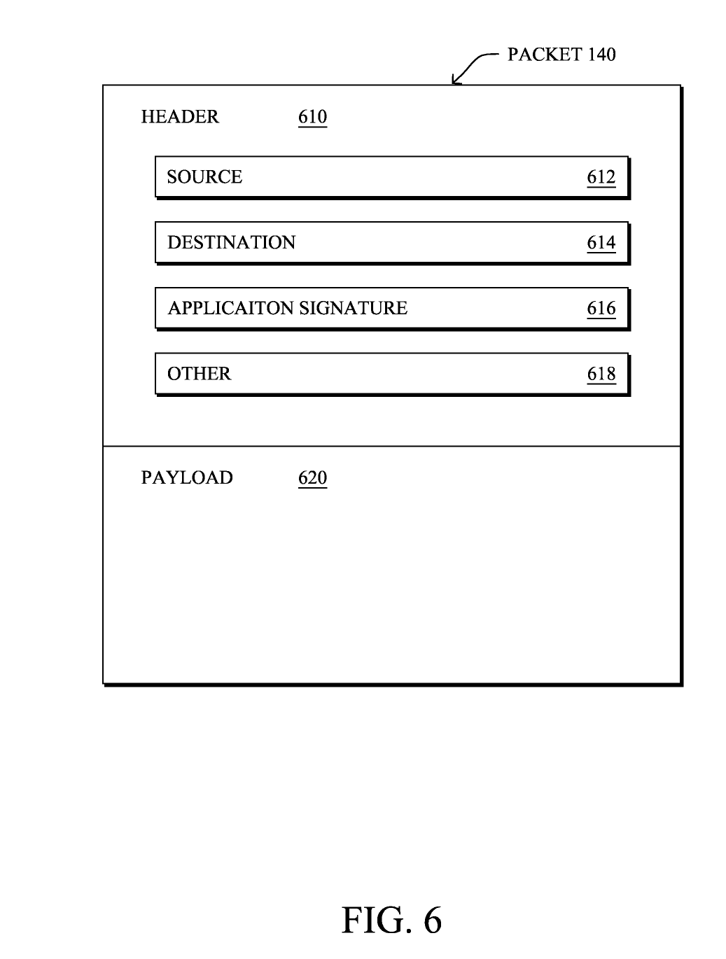

In one embodiment, application signatures within the traffic may be detected, where the signatures are a characteristic of an application (such as ftp, rtp, VoIP, Instant Messaging, etc.). For example, FIG. 6 illustrates an example packet 140, which may comprise one or more headers 610 to forward the packet, and a payload 620 with the carried data. Within the header 610 may be a source address 612 and destination address 614, as well as an “application signature” field 616 or other fields 618. Generally, the application signature may be an explicit value within field 616, such as an identifying value granted to applications utilizing the network, or else may be a more general context of information, e.g., in combination with other fields 618 or even the source or destination address, where a device may be able to infer the application flow. For example, traffic from particular sources or to particular destinations with an associated port value may be determined to be a specific type of traffic, e.g., web-based traffic, peer-to-peer traffic, sensor data collection traffic, etc.

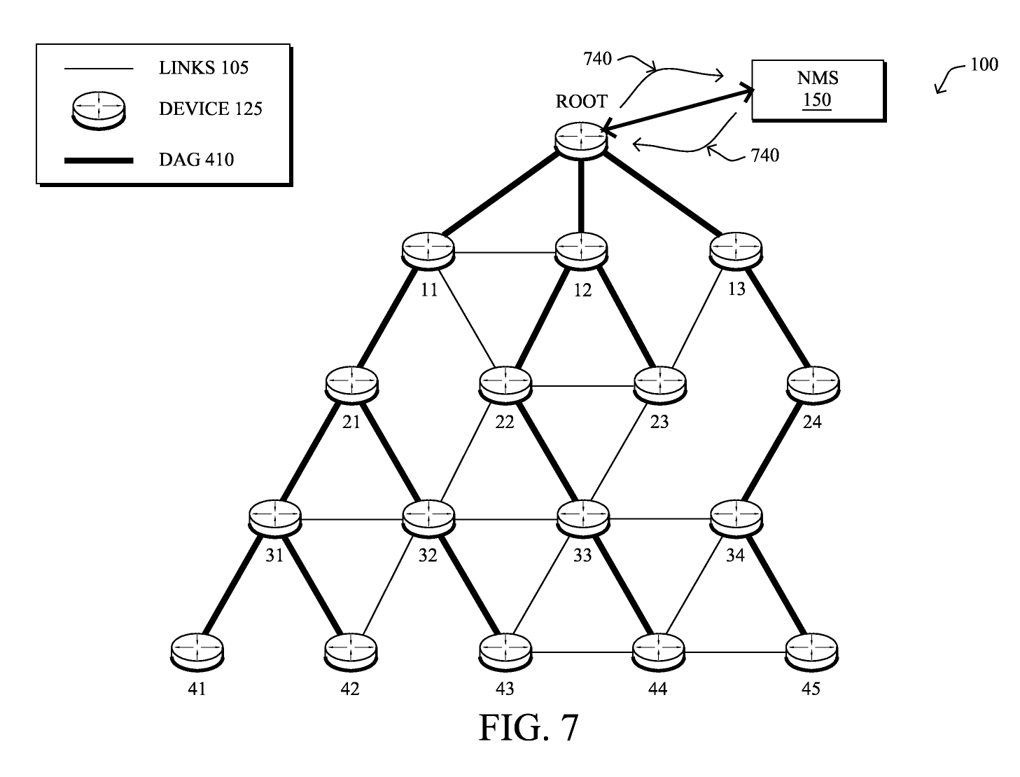

It is worth pointing out that NBAR and DPI are significantly CPU-intensive applications. In accordance with one or more embodiments, these mechanisms (e.g., net-topo process 248) are hosted on the border router, root node, NMS 150, etc., and need not require implementing any of these features on low-power objects in the network (e.g., nodes 125). In yet another embodiment, the border router/root node, if not equipped with NBAR and DPI technology, may send samples of traffic to an NMS 150, as shown in FIG. 7 (messages 740) to perform the tasks described herein. That is, the root node sends traffic samples in messages 740 to the NMS, which receives the samples and then detects the application flow(s). Identification of the flows may then be returned to the root node as returned messages 740. Alternatively, in certain embodiments, the NMS may also perform the remainder of the techniques described below, such as determining traffic requirements, establishing the objective function, and returning the objective function to the root node to initiate creation of the specific routing topology.

In one embodiment, it may first be determined whether the detected application flow merits creation of a specific routing topology, for example, based on whether it is part of a select subset of application flows that have been identified as meriting such creation. In addition, in yet another embodiment, the net-topo process may only trigger the formation of a new routing topology if the flow duration exceeds a duration of time and/or for a minimum amount of traffic (e.g., Kbits/s), i.e., if the application flow is detected for more than a configured length of time (and for a sufficient amount of bandwidth).

For each of these application flows, the net-topo process 248 determines (or assigns) one or more traffic requirements, such as bandwidth, delay, jitter, cost, energy constraints, packet loss, etc., and translates the requirements into a routing topology objective function (e.g., RPL DAG Objective Function). Note that in one specific embodiment, net-topo process may optionally invoke an NMS 150 to correlate the requirement with SLAs (Service Level Agreements), e.g., manually/statically configured on the NMS, to determine the traffic requirements. For example, the net-topo process 248 on a root node may detect a flow from an application “X,” and may send a request (message 740) to the NMS 150 to assign traffic requirements such as bandwidth and delays, or may alternatively locally determine the traffic requirements.

At this point, in certain specific embodiments, in order to limit the number of specific routing topologies in the network, the net-topo process 248 may determine if the detected application could use another existing routing topology that might share similar (or the same) traffic requirements, such as certain delay and packet loss values. Said differently, it may determine whether the particular application flow merits creation of a specific routing topology based on whether another specific routing topology has been created that shares adequately similar traffic requirements as those of the application flow. If there is another topology that may be used, then the application flow may simply be “assigned” to that topology, accordingly.

Once the net-topo process 248 has determined that a new routing topology should be built, and the associated parameters have been computed, the root node (DAG root in the case of RPL) or border router requests the routing protocol (e.g., RPL) to build a corresponding topology (DAG) based on the objective function defined above. That is, creation of a specific routing topology based on the objective function may be correspondingly initiated for use with the application flow.

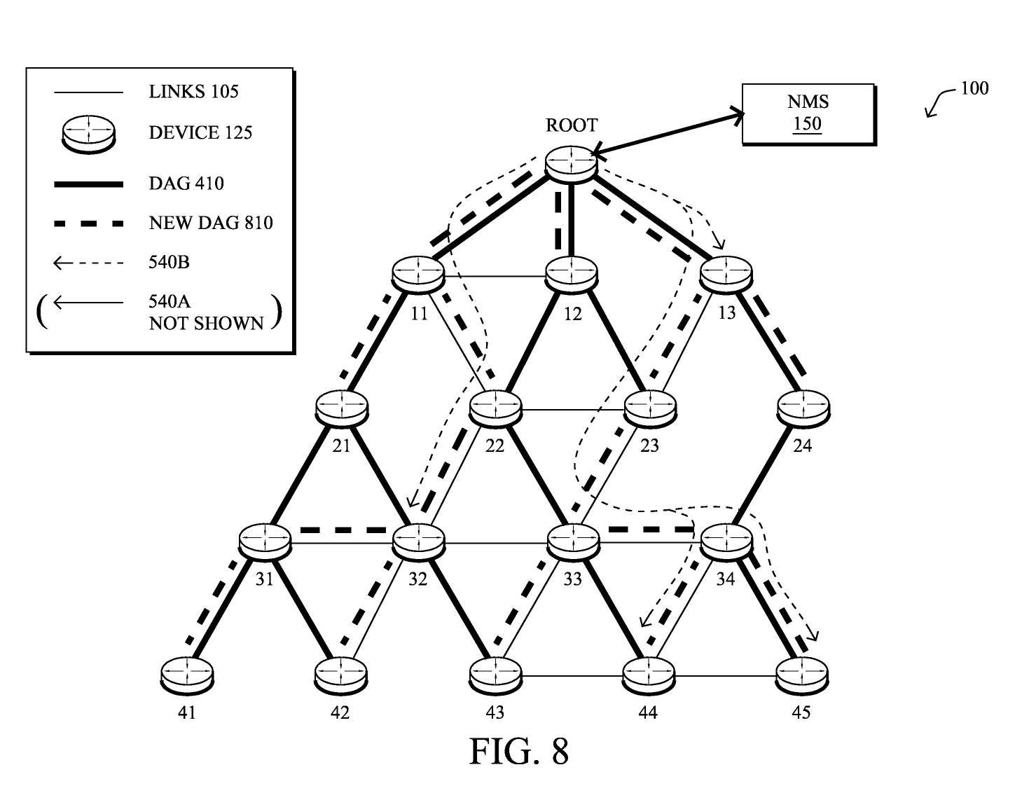

For example, as shown in FIG. 8, assume that application flow 540A (of FIG. 5) was determined to not need a new routing topology, such as due to its being not a selected application type, or else having traffic requirements met by the original topology (DAG 410). On the contrary, flow 540B may have been identified as an application flow that merits a new routing topology, and as such, a new specific routing topology 810 (e.g., a new DAG) may be created, accordingly. For instance, assume that the root node determined the presence of a flow that requires bounded delays and a Packet Delivery Ratio (PDR) of 99.1% because it is TCP-based. The techniques herein may thus build a routing topology that will use the delay as the metric (potentially with a bounded value), excluding links of low reliability (a constraint), and possibly avoiding “sleepy” nodes that add too much delays.

This new topology (DAG 810) may then be maintained for the duration of the traffic flow (e.g., NBAR driven). Note that hysteresis may be used to prevent tearing down a routing topology for a specific flow immediately after the flow has stopped, should the same flow re-appear soon after. That is, the specific routing topology may be maintained for a configured length of time after no longer detecting the application flow. In yet another embodiment, historical data may be stored on the root node so as to determine transient flows, and may be used to not only avoid the formation of very temporary DAGs, but also to keep a DAG if there is a high chance of seeing the same flow shortly after (e.g., maintaining the specific routing topology for a configured length of time based on historical analysis indicative of the application flow being intermittent).

In addition, should there be an NMS 150 monitoring the SLA in the network, the net-topo process 248 may optionally be fed by the monitoring process to dynamically adjust the traffic requirement and tune the objective function, thus hosting a learning machine. In other words, the net-topo process 248 may receive updates to the traffic requirements of the application flow (e.g., from the NMS), and may thus revising the objective function based on the updated traffic requirements and correspondingly initiating revision of the specific routing topology based on the revised objective function.

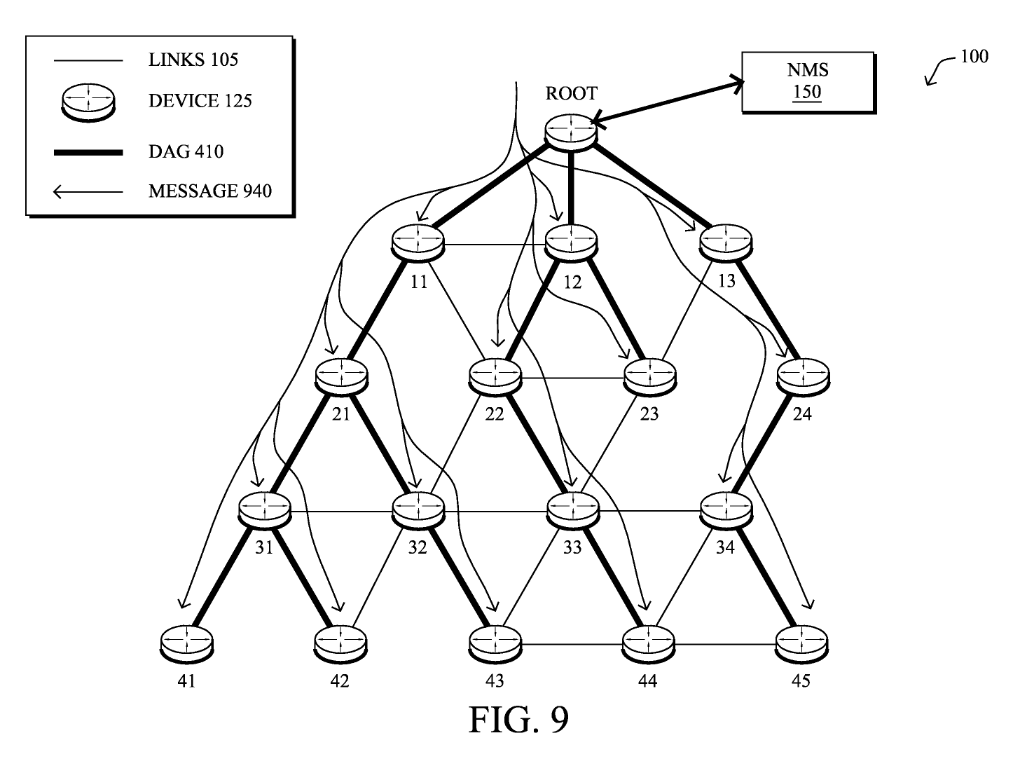

Lastly, in order to allow end nodes (e.g., nodes 125) to insert corresponding traffic into the specific routing topology (e.g., toward the root device, rather than the root device inserting the traffic into the topology toward the nodes 125), the net-topo process 248 may inform the end nodes 125 of the specific routing topology, and a set of rules to apply to application flows in order to utilize the new routing topology. For instance, as shown in FIG. 9, the root node distributes the application marking rules (messages 940) to the nodes 125, for example, using a TLV carried in the routing protocol (e.g., sub-options field 328), so that the end nodes may mark the application traffic flow and steer traffic onto the appropriate topology. Note also that the root node may similarly apply the same marking to the traffic in order to insert the application traffic flows onto the appropriate topology, as well.

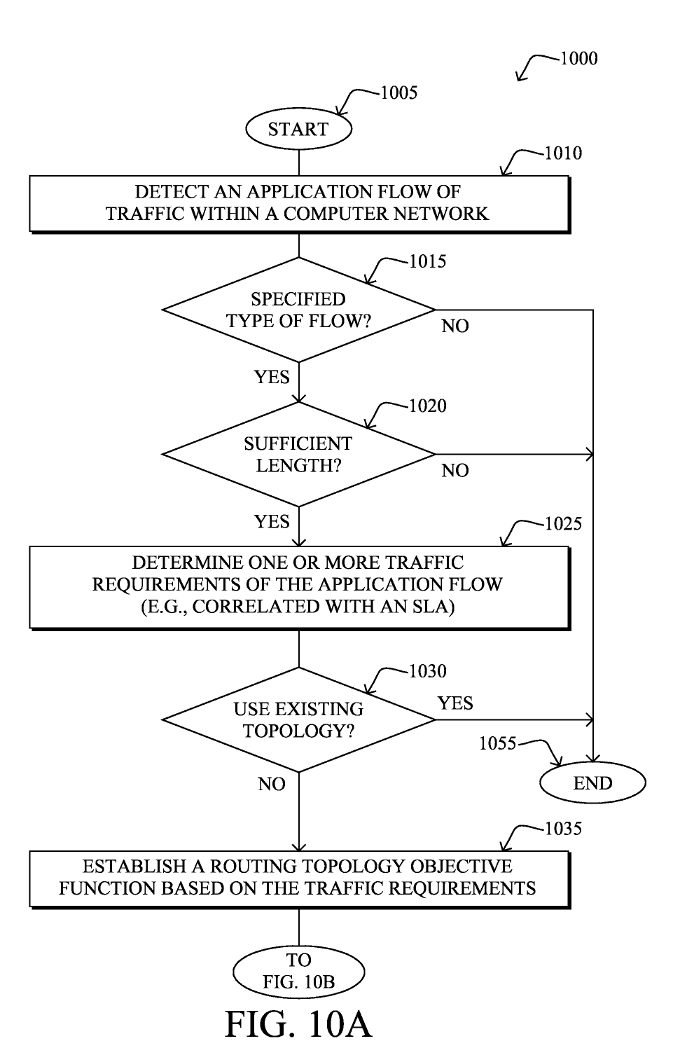

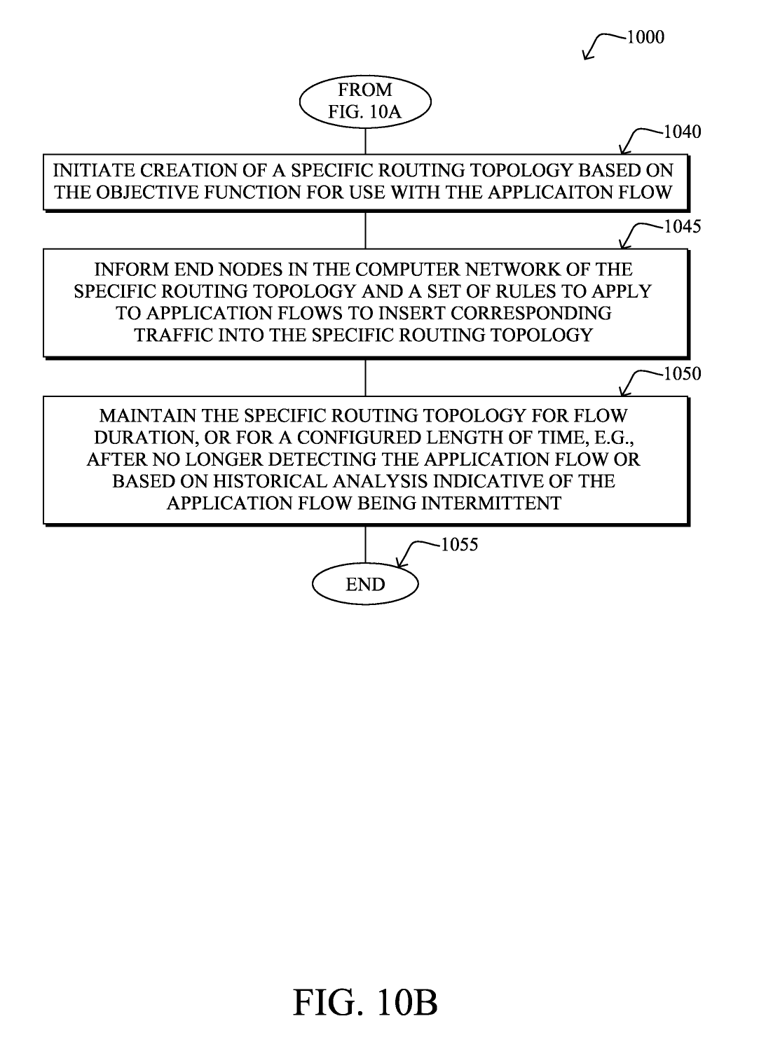

FIGS. 10A-10B illustrate an example simplified procedure for dynamic application-aware routing topologies in a computer network in accordance with one or more embodiments described herein. The procedure 1000 may start at step 1005, and continues to step 1010, where, as described in greater detail above, head-end device, such as a root node, detects an application flow 540 of traffic within a computer network 100, for example, through NBAR, DPI, etc. If the there is a distinction regarding types of flows to which the techniques herein are applied, then if the detected flow matches one of the specified types in step 1015, the head-end device may optionally determine in step 1020 whether the flow has been detected for a sufficient length of time. If so, then in step 1025 one or more corresponding traffic requirements of the application flow may be determined, as described above (e.g., correlated with an SLA). If no other suitable existing topology matches the traffic requirements in step 1030, then an existing topology cannot be used, and the head-end device may establish a routing topology objective function (e.g., a DAG “OF”) based on the traffic requirements in step 1035.

Continuing to FIG. 10B, once the objective function has been established, creation of a specific routing topology (e.g., DAG 810) based on the objective function for use with the application flow may be initiated in step 1040. In step 1045 end nodes in the computer network may be informed of the specific routing topology and a set of rules to apply to application flows to insert corresponding traffic into the specific routing topology. As mentioned above, in step 1050 the specific routing topology may then be maintained for the duration of the flow, or else for a configured length of time, e.g., after no longer detecting the application flow or based on historical analysis indicative of the application flow being intermittent. The procedure 1000 illustratively ends in step 1055.

It should be noted that while certain steps within procedure 1000 may be optional as described above, the steps shown in FIGS. 10A-10B are merely examples for illustration, and certain other steps may be included or excluded as desired. For example, by revisiting steps 1025-1040, upon receiving an update to the traffic requirements of an application flow, the objective function and thus the corresponding routing topology may be revised based on the updated traffic requirements. Further, while a particular order of the steps is shown, this ordering is merely illustrative, and any suitable arrangement of the steps may be utilized without departing from the scope of the embodiments herein. Moreover, while procedure 1000 is shown in separate figures, certain steps from each figure may be incorporated into each other figure, and the figures are not meant to be mutually exclusive.

The techniques described herein, therefore, provide for dynamic application-aware routing topologies in a computer network. In particular, the techniques herein dynamically build and use tailored routing topologies “on-the-fly” based on the detection of application flows, i.e., the specific routing topologies may generally be used only when needed, thus making the network routing much more efficient. This is specifically true for constrained networks (e.g., LLNs) where using the appropriate topology will allow for gains in terms of energy use and network efficiency. Without the techniques herein, forming such routing topologies may be close to impossible in most environments through cumbersome manual configuration, considering the level of complexity and expertise required.

While there have been shown and described illustrative embodiments that provide for dynamic application-aware routing topologies in a computer network, it is to be understood that various other adaptations and modifications may be made within the spirit and scope of the embodiments herein. For example, the embodiments have been shown and described herein with relation to LLNs, and more particularly, the RPL protocol. However, the embodiments in their broader sense are not as limited, and may, in fact, be used with other types of networks and/or protocols, and those shown herein are merely illustrative examples. Also, while the techniques generally show and describe intelligence being performed by a root node, the term “root node” generally implies any intelligent head-end node, border router, NMS, etc. capable of detecting flows and influencing creating of a routing topology within a computer network.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
detecting an application flow of traffic within a computer network;
determining one or more traffic requirements of the application flow;
establishing a routing topology objective function based on the traffic requirements; and
initiating creation of a specific routing topology based on the objective function for use with the application flow.

2. The method as in claim 1, wherein detecting comprises:
utilizing a detection mechanism selected from a group consisting of: detecting an application signature in the traffic; utilizing network-based application recognition (NBAR); and utilizing deep packet inspection (DPI).

3. The method as in claim 1, further comprising:
determining whether the application flow merits creation of a specific routing topology as being one of a select subset of application flows that merit creation of a specific routing topology.

4. The method as in claim 1, further comprising:
determining whether the application flow merits creation of a specific routing topology based on whether another specific routing topology has been created that shares adequately similar traffic requirements as those of the application flow.

5. The method as in claim 1, wherein traffic requirements are selected from a group consisting of: bandwidth; delay; jitter; cost; energy constraints; and packet loss.

6. The method as in claim 1, further comprising:
correlating the application flow with a service level agreement (SLA) to determine the traffic requirements.

7. The method as in claim 6, wherein correlating comprises:
requesting, by a root node of the computer network, correlation from a network management server (NMS).

8. The method as in claim 1, further comprising:
receiving updates to the traffic requirements of the application flow; and
revising the objective function based on the updated traffic requirements; and
initiating revision of the specific routing topology based on the revised objective function.

9. The method as in claim 1, further comprising:
creating the specific routing topology in response to the application flow being detected for more than a configured length of time.

10. The method as in claim 1, further comprising:
maintaining the specific routing topology for a configured length of time after no longer detecting the application flow.

11. The method as in claim 1, further comprising:
maintaining the specific routing topology for a configured length of time based on historical analysis indicative of the application flow being intermittent.

12. The method as in claim 1, further comprising:
receiving samples of traffic at a network management server (NMS) from a root node of the computer network through which the traffic traverses, wherein the NMS detects the application flow, determines the traffic requirements, and establishes the objective function; and
returning the objective function to the root node to initiate creation of the specific routing topology.

13. The method as in claim 1, further comprising:
informing one or more end nodes in the computer network of the specific routing topology and a set of rules to apply to application flows to insert corresponding traffic into the specific routing topology.

14. An apparatus, comprising:
one or more network interfaces to communicate with computer network;
a processor coupled to the network interfaces and adapted to execute one or more processes; and
a memory configured to store a process executable by the processor, the process when executed operable to:
detect an application flow of traffic within the computer network;
determine one or more traffic requirements of the application flow;
establish a routing topology objective function based on the traffic requirements; and
initiate creation of a specific routing topology based on the objective function for use with the application flow.

15. The apparatus as in claim 14, wherein the process when executed to detect is further operable to:
utilize a detection mechanism selected from a group consisting of: detecting an application signature in the traffic; utilizing network-based application recognition (NBAR); and utilizing deep packet inspection (DPI).

16. The apparatus as in claim 14, wherein the process when executed is further operable to:
determine whether the application flow merits creation of a specific routing topology as being one of a select subset of application flows that merit creation of a specific routing topology.

17. The apparatus as in claim 14, wherein the process when executed is further operable to:
determine whether the application flow merits creation of a specific routing topology based on whether another specific routing topology has been created that shares adequately similar traffic requirements as those of the application flow.

18. The apparatus as in claim 14, wherein the process when executed is further operable to:
create the specific routing topology in response to the application flow being detected for more than a configured length of time.

19. The apparatus as in claim 14, wherein the process when executed is further operable to:
maintain the specific routing topology for a configured length of time after no longer detecting the application flow.

20. The apparatus as in claim 14, wherein the process when executed is further operable to:
maintain the specific routing topology for a configured length of time based on historical analysis indicative of the application flow being intermittent.

21. The apparatus as in claim 14, wherein the process when executed is further operable to:
inform one or more end nodes in the computer network of the specific routing topology and a set of rules to apply to application flows to insert corresponding traffic into the specific routing topology.

22. A tangible, non-transitory, computer-readable media having software encoded thereon, the software when executed by a processor operable to:
detect an application flow of traffic within the computer network;
determine one or more traffic requirements of the application flow;
establish a routing topology objective function based on the traffic requirements; and
initiate creation of a specific routing topology based on the objective function for use with the application flow.
